(19) United States
(12) Patent Application Publication
(10) Pub. No.: US 2004/0089698 A1
(43) Pub. Date: May 13, 2004

(54) Connection between an outer joint part or an outer sleeve part and a tube end

(76) Inventors: Herbert Cermak, Bessenbach (DE); Dirk Winkler, Rodgau (DE)

Correspondence Address: Robert P. Renke, Suite 250, 28333 Telegraph Road, Southfield, MI, 48034, US

(21) Appl. No.: 10/641,469

(22) Filed: Aug. 14, 2003

(30) Foreign Application Priority Data
Aug. 14, 2002 (DE) 102 37 215.2

(51) Int. Cl. B23K 20/08

(52) U.S. Cl. 228/107

(57) ABSTRACT

A method of producing a connection between an outer joint part of a constant velocity universal joint and a shaft journal, wherein the shaft journal is provided with a flange which is co-axially attached to the outer joint part, wherein a tubular sleeve with a greater diameter is slid at a radial distance over the butt joint between the outer joint part and the flange and wherein the tubular sleeve is reduced radially by a pulse welding process and welded to the outer joint part and to the flange.

### TECHNICAL FIELD

The invention relates to a method of producing a connection between an outer joint part of a constant velocity universal joint and a shaft journal. It also relates to a method of producing a connection between an outer joint part of a constant velocity universal joint and a shaft tube. It further relates to a method of producing a connection between an outer sleeve part of an axial plunging ball splines device and a shaft tube.

### BACKGROUND OF THE INVENTION

In many cases, the outer joint parts of constant velocity joints are produced with integrally formed-on shaft journals, which results in a relatively heavy component. The shaft journal has to be individually adapted to each specific application. This leads to an undesirably large variety of parts. In other cases, the outer joint parts of constant velocity joints are produced with apertures at both ends to form so-called disc joints. The outer joint parts of disc joints are normally connected to attaching flanges by means of threaded connections. This provides more design possibilities when designing the adjoining shaft journal, but because of the threaded connection, the number of machining operations and the number of parts are high.

It is also known to weld the outer joint parts of disc joints and the outer sleeve parts of ball splines devices directly into tubular shafts. This requires accurate machining of the mating surfaces at the outer joint part and the outer sleeve part respectively and at the tube to ensure that the outer joint part and the outer sleeve part respectively is centered and accurately axially positioned in the tube end for the purpose of producing an out-of-balance-free connection.

From DE 199 02 122 A1 and U.S. Pat. No. 5,981,921 it is known to produce vehicle driveshafts by connecting universal joint yokes and splined tubular shafts to tubular shafts by a magnetic pulse welding process. The parts to be connected are provided with a special neck portion which is introduced into the open end of the tubular shaft.

### SUMMARY OF THE INVENTION

The present invention provides a method of connecting outer joint parts and outer sleeve parts respectively to shaft journals and tubular shafts. The method can be carried out cost-effectively and results in lightweight connected assemblies.

A first solution provides a method of producing a connection between an outer joint part of a constant velocity universal joint and a shaft journal. The shaft journal is provided with a flange which is co-axially attached to the outer joint part, and a tubular sleeve with a greater diameter is slid at a radial distance over the butt joint between the outer joint part and the flange. The tubular sleeve is reduced radially by a pulse welding process and welded to the outer joint part and to the flange. There is thus provided a connection wherein initially the outer joint part can optionally be produced in the form of a disc joint or with a relatively lightweight base and, separately therefrom, the shaft journal can be produced with a flange which is also lightweight. The deformation processes for both parts are much more advantageous than in the case of an outer joint part which is produced with an integrally formed-on shaft journal. More particularly, said parts, i.e. the outer joint part and the shaft journal with the flange, can be positioned side by side with identical diameters to form a butt joint and can be connected by the slid-on tubular sleeve without the need for further preparatory measures, using a pulse welding method. In particular, it has to be emphasised that the degree of accuracy of the surfaces to be connected does not have to be particularly high, so that those component surfaces can already be completed in the course of the non-chip-producing forming operation; there is no need for the connecting faces to be machined. In a simple case, the connecting faces can be purely cylindrical, but optionally they can also be provided with cross-sectional profiling.

In addition to the welded connection between the tubular sleeve and the outer joint part on the one hand and the flange on the other hand, there is achieved a torsionally rigid form-fitting connection between the tubular sleeve and the parts. During the pulse welding process, high radial acceleration forces are applied to the tubular sleeve which is initially arranged so as to be centered with radial play relative to the connecting faces. The tubular sleeve is greatly radially upset, with the deformation speed being so high that, when the tubular sleeve hits the connecting faces, there is produced a weld. The tubular sleeve preferably is made of the same material as the components to be connected. However, it is also possible to use different metals. In particular, the tubular sleeve can comprise an aluminium alloy.

A second solution provides a method of producing a connection between an outer joint part of a constant velocity universal joint and a shaft tube wherein the outer joint part is produced with a circumferential connecting face, and wherein the shaft tube is provided with a tube end which has a greater diameter than the connecting face. The tube end of the shaft tube is slid over the outer joint part at a radial distance therefrom and is radially reduced by a pulse welding process and welded to the outer joint part. There is thus provided a method wherein outer joint parts of disc joints, but also joints with a formed-on lightweight base can be secured in an open end of a tubular shaft. This is particularly advantageous in the case of tubular shafts with a large diameter such as are used in propeller shafts of motor vehicles. The respective tubular shaft which, overall, can have a smaller diameter than the outer joint part can comprise one end with a widened diameter into which the outer joint part can be inserted with radial play. After the outer joint part has been concentrically inserted into the tube end, there is carried out a pulse welding method whose effect, in this case, is limited to the tube end. The operation of upsetting the tube end in a pulse-like way leads to a welded connection between the reduced tube end and the circumferential connecting face of the outer joint part. In this case, too, the circumferential connecting face can be purely cylindrical or comprise a profiled cross-section. In the latter case, there is additionally achieved a positive, form-fitting connection between the tube end and the outer joint part, which connection can be subjected to torsion loads. The profiling can be achieved more particularly in that the outer joint part is a formed metal part whose outer contour is determined by the cross-sectional shape of the ball tracks. This is particularly advantageous in that the tube end which is welded in a planar way contributes considerably to the dimensional stability of the outer joint part, which in formed plate metal joint components is initially lower than in solid joint components.

According to a further embodiment it is advantageous if, before the outer joint part is inserted into the open tube end, there is first inserted a cover which closes the cross-section of the tube. The cover can be positioned against an inner step in the tube, which step should be provided in an axial region in which the radial upset of the cross-section of the tube by the pulse welding method is still exerting its effect. As a result, the cover as well as the outer joint part in the tube are additionally clamped in.

According to a further advantageous embodiment, after the outer joint part has been inserted into the open tube end, a sleeve, for example for securing a rolling boot, is slid into the open tube end. The sleeve, too, is clamped in at least in a force-locking way after the cross-section of the tube has been radially upset.

Both the cover and the sleeve can be partially slid on to the outer joint part prior to carrying out the pulse welding operation, so that they are at least partially clamped in between the outer joint part and the tubular shaft, and preferably, they are also at least partially welded to the parts while the pulse welding process is carried out. For this method, too, the material for the tubular shaft can be a light metal alloy.

A third solution provides a method of producing a connection between an outer sleeve part of a ball splines axial plunging device for torque transmission and a shaft tube wherein the outer sleeve part is produced with a circumferential connecting face, and wherein the shaft tube is provided with a tube end which has a greater diameter than the connecting face. The tube end of the shaft tube is slid over the outer sleeve part at a radial distance therefrom and is radially reduced by a pulse welding process and welded to the outer sleeve part. There is thus provided a method wherein outer sleeve parts of axial plunging devices for torque transmission through balls in ball splines can be secured in an open end of a tubular shaft. This is particularly advantageous in the case of tubular shafts with a large diameter such as are used in propeller shafts of motor vehicles. The respective tubular shaft which, overall, can have a smaller diameter than the outer sleeve part can comprise one end with a widened diameter into which the outer sleeve part can be inserted with radial play. After the outer sleeve part has been concentrically inserted into the tube end, there is carried out a pulse welding method whose effect, in this case again, is limited to the tube end. The operation of upsetting the tube end in a pulse-like way leads to a welded connection between the reduced tube end and the circumferential connecting face of the outer sleeve part. In this case, too, the circumferential connecting face can be purely cylindrical or comprise a profiled cross-section. In the latter case, there is additionally achieved a positive, form-fitting connection between the tube end and the outer sleeve part, which connection can be subjected to torsion loads. The profiling can be achieved more particularly in that the outer sleeve part is a formed metal part whose outer contour is determined by the cross-sectional shape of the ball splines. This is particularly advantageous in that the tube end which is welded in a planar way contributes considerably to the dimensional stability of the outer sleeve part, which in formed plate metal sleeve components, is initially lower than in solid sleeve components.

According to a further embodiment it is advantageous if, before the outer sleeve part is inserted into the open tube end, there is first inserted a cover which closes the cross-section of the tube. The cover can be positioned against an inner step in the tube, which step should be provided in an axial region in which the radial upset of the cross-section of the tube by the pulse welding method is still exerting its effect. As a result, the cover as well as the outer sleeve part in the tube are additionally clamped in.

A magnetic pulse welding method is preferably used for accelerating the tubular sleeve or the tube end. This presupposes that an electrically conducting material is used for the sleeve or the tube. In the case of the magnetic pulse welding process, electric energy is stored in electric capacitors and transmitted via a discharging to a coil-shaped inductor which is arranged at a distance radially outside the sleeve or the tube end and the outer joint part. As a result, an extremely powerful magnetic field is built up in the shortest possible time. This applies to the sleeve or the tube end a high acceleration force which is directed radially inwardly in the inductor, i.e. to the longitudinal axis of the shaft. It is also possible to use an explosive pulse welding method (pyrotechnical method), in which case only the weldability of the materials of the sleeve or the tube and the outer joint part has to be taken into account. In the case of the explosive welding method, an explosive in which there is stored chemical energy is applied to the radial outside of the sleeve or the tube end with reference to the longitudinal axis of the shaft, and made to detonate. On the radial outside of the sleeve or the tube end, there can be provided a dam in the form of tube slid on to the sleeve or the tube end and the outer joint part. The increase in pressure occurring in the course of the detonation applies a high acceleration force to the sleeve or the tube end, which force is to be directed radially towards the longitudinal axis of the shaft.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows an inventive connection between an outer joint part and a shaft journal.

FIG. 2 shows an inventive connection between an outer joint part and a tubular shaft.

FIG. 3 shows an inventive connection between an outer joint part and a tubular shaft, incorporating further elements.

FIG. 4 shows an inventive connection between an outer sleeve part and a tubular shaft:

A) in a longitudinal section

B) in cross section.

FIG. 5 shows an inventive connection between an outer joint part and a tubular shaft, incorporating a cover in a first embodiment:

A) in a longitudinal section

B) in cross section.

FIG. 6 shows an inventive connection between an outer joint part and a tubular shaft, incorporating a cover in a second embodiment:

A) in a longitudinal section

B) in cross section.

FIG. 7 shows an inventive connection between an outer joint part and a tubular shaft, incorporating a cover in a third embodiment:

A) in a longitudinal section

B) in cross section.

### DETAILED DESCRIPTION

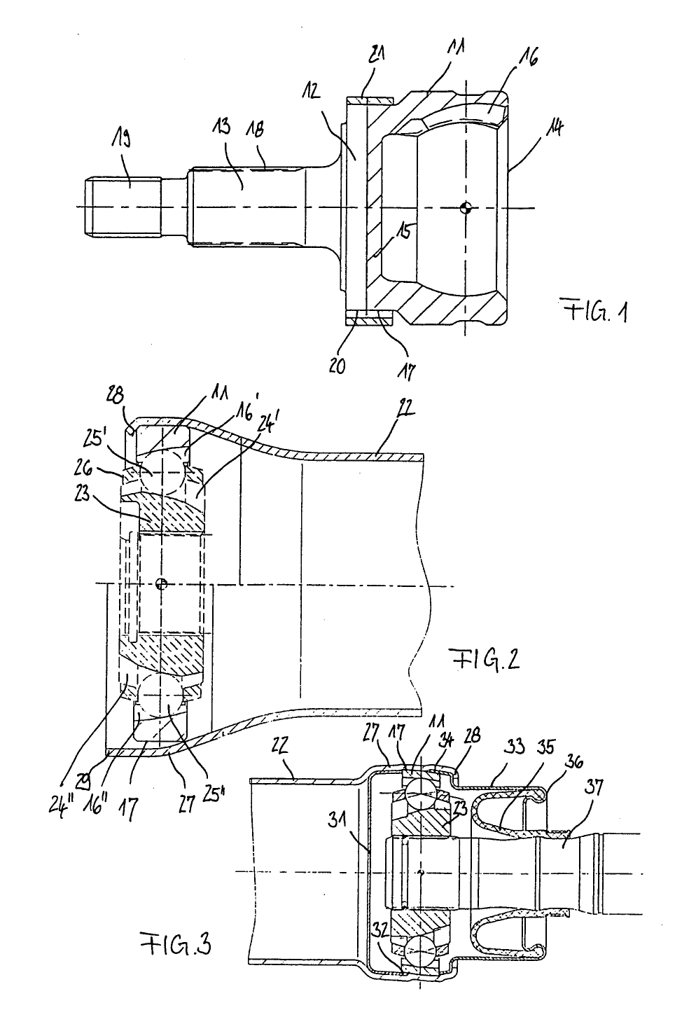

FIG. 1 is a longitudinal section through an outer joint part 11 of a constant velocity fixed ball joint to which there is attached a shaft journal 13 produced integrally with a flange 12. The outer joint part comprises an aperture 14 from which the remaining elements of the joint can be inserted, a base 15 and ball tracks 16, one of which is shown. In the region of the base 15, the outer joint part comprises a cylindrical connecting face 17. The shaft journal 13 is shown to comprise a shaft profile 18 and a threaded journal 19. In the region of the flange 12, the shaft journal comprises a cylindrical connecting face 20. The connecting faces 17, 20 have identical diameters. The base 15 of the outer joint part and the flange 12 abut one another in a planar way. A tubular sleeve 21 is slid over the two connecting regions 17, 20 and, in accordance with the illustration, in the lower half of same, is initially provided with radial play relative to the connecting faces and, in the upper half, after having been subjected to a pulse welding method, is positioned in a play-free way on the connecting faces 17, 20 and is cold-welded thereto. In this way, it is possible to produce a coaxial, bending- and torsion-resistant connection between the outer joint part 11 and the shaft journal 13. While the pulse welding process is carried out, the outer joint part and the shaft journal can be clamped in concentrically. However, due to the reduction in the tubular sleeve, the two parts are centered additionally during the welding operation. Whereas the outer joint part 11 and the shaft journal 13 consist of steel, the tubular sleeve 21 can be made of steel or of aluminium.

FIG. 2 shows the connection between an outer joint part 11 of a constant velocity universal joint and a tubular shaft 22 in accordance with the invention. The outer joint part 11 is provided in the form of a disc joint with apertures at both ends, and comprises a cylindrical fixing face 17. In the present case, the outer joint part 11 comprises circumferentially alternately formed ball tracks 16′, 16″. The remaining parts of the constant velocity universal joint are shown in dashed lines, i.e. the inner joint part 23 with ball tracks 24′, 24″, balls 25′, 25″ and a ball cage 26. The joint as illustrated is a so-called counter track joint wherein the pairs of tracks 16′, 24′ and 16″, 24″ respectively open alternately in opposite directions across the circumference. This is of no significance for the subject of the present invention. The tube end 29 of the shaft tube 22 is formed by a widened portion 27, so that the tube end 29 can be slid with radial play over the outer joint part, as shown in the lower half of the Figure, whereas the shaft tube 22 itself comprises a smaller outer diameter than the outer joint part 11. After the pulse welding process has been carried out, as shown in the upper half of FIG. 2, the tube end 29, while forming a beading 28, is positioned in a play-free way on the outer joint part 11 and is cold-welded thereto. The connection between the shaft tube and the outer joint part can preferably be produced when the constant velocity universal joint is already fully assembled, thus permitting unimpeded joint mounting.

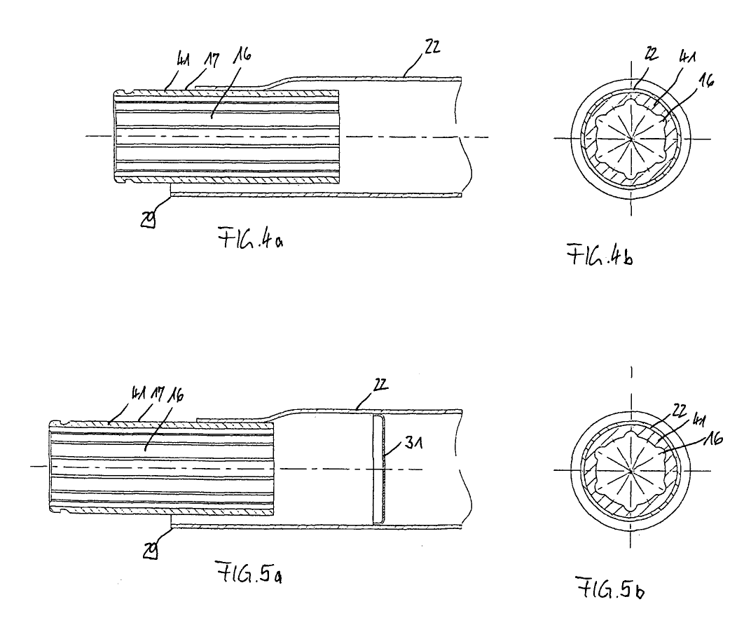

FIG. 3 shows an inventive connection between the outer joint part 11 of a constant velocity universal joint and a shaft tube 22. The Figure shows further elements which will be described later. In this case, too, there is shown a complete constant velocity universal joint in the form of a counter track joint, but it is shown in continuous lines, with the individual parts of the joint not having been given individual reference numbers. The outer joint part 11 deviates from that according to FIG. 2 in that it comprises a circumferential connecting face 17 with a non-cylindrical cross-sectional and longitudinal contour. The outer joint part 11 is shown in the form of a formed plate metal part with an approximately uniform wall thickness, so that a widened portion 27 at the tube end 29 of the tubular shaft 22 is cold welded to, and positioned in a positive and form-fitting way on, the connecting face 17 of the outer joint part 11. Into the widened portion 27 of the tubular shaft 22 there is inserted a cover 31 which partially abuts the outer joint part 11 (lower half of the Figure) and is partially positioned with lobes 32 between the outer joint part 11 and the tubular shaft 22, where it is clamped in and cold-welded to said parts. Furthermore, a plate metal sleeve 33 is inserted between the open tube end 29 of the tubular shaft 22 and partially circumferentially abuts the outer joint part 11 (upper half of the Figure) and is partially clamped in with lobes 34 between the outer joint part 11 and the tube end 29 and is cold-welded to said parts. A beading 28 at the tube end 29 of the tubular shaft 22 surrounds the plate metal sleeve 33. The plate metal sleeve 33 carries a rolling boot 35 which is clamped in by a beading 36 of the sleeve 33 and, furthermore, is clamped on to a shaft 37 which is inserted into the inner joint part 23 of the joint. Prior to producing the welded connection between the tubular shaft 22 and the outer joint part 11, the cover 31 and the sleeve 33 can substantially comprise their finished form as illustrated. However, slight deformation during the execution of the pulse welding process is possible.

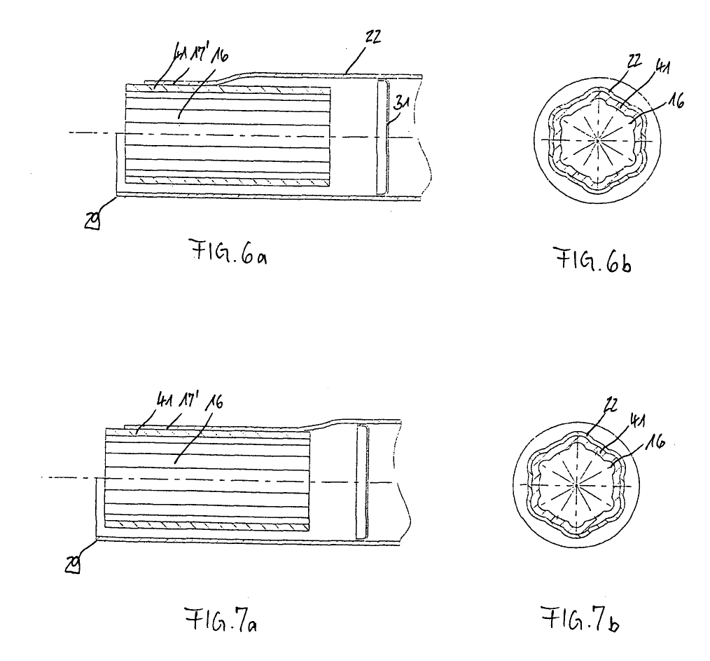

FIGS. 4 to 7 each show the connection between an outer sleeve part 41 of an axial plunging ball splines device and a tubular shaft 22 in accordance with the invention. The upper half of each Figure shows the assembly after the pulse welding process has been carried out, and the lower half of each Figure shows the assembly before pulse welding. The outer sleeve part 41 is provided in the form of a constant cross section profile and comprises a cylindrical fixing face 17 in FIGS. 4 and 5 and a profiled fixing face 17′ in FIGS. 6 and 7. The outer sleeve part 41 comprises circumferentially evenly distributed ball splines 16. The tube end 29 of the shaft tube 22 originally has a larger diameter than the outer sleeve part 41, so that the tube end 29 can be slid with radial play over the outer sleeve part, as shown in the lower half of the Figures, whereas the shaft tube 22 after the pulse welding process has been carried out, as shown in the upper half of the Figures, comprises a corresponding diameter to the outer sleeve part 41. Herein the tube end 29 is positioned in a play-free way on the outer sleeve part 41 and is cold-welded thereto. The connection between the shaft tube and the outer sleeve part can be produced over different axial length portions of the outer sleeve part, as shown in FIGS. 4 to 7. In FIGS. 5 to 7 there is inserted a cover 31 into the end portion of the tubular shaft 22 with a pressure fit.

While the invention has been described in connection with several embodiments, it should be understood that the invention is not limited to those embodiments. Thus, the invention covers all alternatives, modifications, and equivalents as may be included in the spirit and scope of the appended claims.

What is claimed is:

1. A method of producing a connection between an outer joint part (11) of a constant velocity universal joint and a shaft journal (13), wherein the shaft journal (13) includes a flange (12) which is co-axially attached to the outer joint part (11), the method comprising:
sliding, at a radial distance, a tubular sleeve (21) with a greater diameter over the butt joint between the outer joint part (11) and the flange (12); and
reducing the tubular sleeve (21) radially by a pulse welding process and welding the tubular sleeve (22) to the outer joint part (11) and to the flange (12).

2. A method according to claim 1, comprising cylindrical circumferential connecting faces (17, 20) adjoining the butt joint at the outer joint part (11) and at the flange (12).

3. A method according to claim 1, comprising profiled circumferential connecting faces (17, 20) adjoining the butt joint at the outer joint part (11) and at the flange (12).

4. A method of producing a connection between an outer joint part (11) of a constant velocity universal joint and a shaft tube (22), wherein the outer joint part (11) includes a circumferential connecting face (17), and the shaft tube (22) includes a tube end (29) with a greater diameter than the connecting face (17), the method comprising:
sliding the tube end (29) of the shaft tube (22) over the outer joint part (11) at a radial distance therefrom; and
radially reducing the tube end (29) by a pulse welding process and welding the shaft tube (22) to the outer joint part (11).

5. A method according to claim 4, wherein the circumferential connecting face (17) of the outer joint part (11) is cylindrical.

6. A method according to claim 4, wherein the circumferential connecting face (17) of the outer joint part (11) is profiled.

7. A method according to claim 4, comprising, prior to sliding the tube end (29) on to the outer joint part (11), sliding a dish-shaped cover (31) into the open tube end (29) for sealing the inner cross-section of the tube, and radially clamping the dish-shaped cover (31) near the tube end (29) while the tube end (29) is being radially reduced.

8. A method according to claim 4, comprising, after sliding the tube end on to the outer joint part, sliding a plate-metal sleeve (33) into the open tube end (29), and radially clamping the plate-metal sleeve (33) in while the tube end (29) is being radially reduced.

9. A method according to claim 7, comprising, while the tube end is being radially reduced, clamping a beaded edge of the cover (31) in between the outer joint part (11) and the tube end (29).

10. A method according to claim 8, comprising, while radially reducing the tube end (29), clamping an end portion of the plate-metal sleeve (33) in between the outer joint part (11) and the tube end (29).

11. A method of producing a connection between an outer sleeve part (11) of a ball splines axial plunging device and a shaft tube (22), wherein that the outer sleeve part (41) is produced with a circumferential connecting face (17), and the shaft tube (22) includes a tube end (29) with a greater diameter than the connecting face (17), the method comprising:
sliding, the tube end (29) of the shaft tube (22) over the outer sleeve part (41) at a radial distance therefrom, and radially reducing the tube end (29) by a pulse welding process and welding the shaft tube (22) to the outer sleeve part (41).

12. A method according to claim 11, wherein the circumferential connecting face (17) of the outer sleeve part (41) is cylindrical.

13. A method according to claim 11, wherein the circumferential connecting face (17) of the outer sleeve part (41) is profiled.

14. A method according to claim 11 comprising, prior to sliding the tube end (29) being on to the outer sleeve part (41), sliding a dish-shaped cover (31) into the open tube end (29) for sealing the inner cross-section of the tube, and radially clamping the dish-shaped cover (31) near the tube end (29) while the tube end (29) is being radially reduced.

15. A method according to claim 1, wherein a magnetic pulse welding process is used.

16. A method according to claim 4, wherein a magnetic pulse welding process is used.

17. A method according to claim 11, wherein a magnetic pulse welding process is used.

18. A method according to claim 1, wherein an explosive pulse welding process is used.

19. A method according to claim 4, wherein an explosive pulse welding process is used.

20. A method according to claim 11, wherein an explosive pulse welding process is used.
